(19) United States
(12) Patent Application Publication
(10) Pub. No.: US 2026/0217053 A1
(43) Pub. Date: Jul. 30, 2026

(54) Multifunctional Smart Markerboard with Dynamic LED Illumination and Audio Integration

(71) Applicant: Joshua Sanders, Forney, TX (US)

(72) Inventor: Joshua Sanders, Forney, TX (US)

(21) Appl. No.: 19/442,004

(22) Filed: Jan. 7, 2026

Related U.S. Application Data
(60) Provisional application No. 63/745,473, filed on Jan. 15, 2025.

(51) Int. Cl. B43L 1/00; G06F 3/16; H05B 47/12

(52) U.S. Cl. CPC B43L 1/004; G06F 3/162; H05B 47/12

(57) ABSTRACT

An interactive markerboard device designed to enhance creativity while minimizing screen time is disclosed. The device comprises a transparent, shatter-resistant glass markerboard surface for use with liquid neon-colored dry erase ‘chalk’ markers, a plurality of addressable RGB LEDs embedded in the casing around the periphery for customizable illumination, and a Bluetooth speaker for audio playback. A durable and waterproof casing is disposed along a periphery or perimeter of the glass markerboard surface, the casing encloses and protects internal electronic components of the interactive markerboard device. A microcontroller processes audio signals received via Bluetooth, extracting frequency components to synchronize LED lighting effects with music beats. The device can enable automatic conversion of handwritten notes into digital text and real-time drawing assistance. The system is powered by a rechargeable, replaceable battery.

### CROSS-REFERENCE TO RELATED APPLICATION

The present application claims priority to, and the benefit of, U.S. Provisional Application No. 63/745,473, which was filed on Jan. 15, 2025, and is incorporated herein by reference in its entirety.

### FIELD OF THE INVENTION

The present invention generally relates to interactive display devices. More specifically, the invention relates to an interactive markerboard device that integrates RGB LED illumination and Bluetooth audio synchronization to enhance creative expression while minimizing screen time. The device features a transparent, shatter-resistant glass markerboard surface that enables users to write or draw using liquid neon-colored dry erase ‘chalk’ markers, providing a reusable and mess-free alternative to traditional markerboards and whiteboards. The embedded RGB LEDs illuminate the board in customizable colors and dynamic patterns, while the Bluetooth speaker enables music playback, with the LEDs synchronizing in real time to music beats. Accordingly, the present disclosure makes specific reference thereto. Nonetheless, it is to be appreciated that aspects of the present invention are also equally applicable to other like applications, devices, and methods of manufacture.

### BACKGROUND

By way of background, traditional markerboards have long been used for writing and drawing in educational, professional, and creative environments. However, traditional markerboards have limited functionality, and standard markerboards produce dust, which can be messy and cause respiratory issues, particularly for children and individuals with allergies. Furthermore, chalk sticks break easily and wear out quickly, requiring frequent replacements. On the other hand, dry erase boards offer a cleaner alternative but have limitations as dry erase markers often dry out rapidly, require constant replacement, and their ink can smear, making them less effective for long-term use.

In today's digital age, children and adults spend excessive time on smartphones, tablets, and computers, which can limit hands-on creativity and imagination. Excessive screen exposure may contribute to eye strain, reduced attention span, and lack of tactile engagement. As a result, there is a need for an interactive, engaging, and reusable medium that fosters creativity while reducing dependency on electronic screens.

Therefore, there exists a long-felt need in the art for an interactive markerboard device that enhances creativity while reducing reliance on traditional markerboards and digital screens. There is a long-felt need for a mess-free writing and drawing solution that eliminates chalk dust and the frequent replacement of dry erase markers. Additionally, there is a long-felt need for an illuminated markerboard surface that enhances visibility in dim environments and adds a dynamic visual effect for entertainment, education, and creative expression. Furthermore, there exists a long-felt need in the art for an interactive writing surface that integrates multimedia functionality, enabling users to experience synchronized lighting and music playback. More specifically, there exists a long-felt need for a smart markerboard that synchronizes LED lighting with music beats, creating an engaging and immersive experience. Also, there is a long-felt need in the art for a wirelessly connected markerboard device that enables users to pair the markerboard with an electronic device via Bluetooth to play music and audio. Finally, there is a long-felt need for an eco-friendly, rechargeable, and multi-functional markerboard system that offers a creative drawing surface for individuals to draw, write, and express themselves on.

The subject matter disclosed and claimed herein, in one embodiment, comprises an interactive markerboard device equipped with a transparent, shatter-resistant glass surface that supports liquid neon-colored dry erase ‘chalk’ markers. The device further comprises a plurality of RGB LEDs embedded along and around the periphery, configured to illuminate the board surface in static or dynamic color variations. A Bluetooth speaker is integrated within the casing, enabling users to pair an external electronic device and play music. The system further includes a microcontroller configured to process audio signals, extract frequency components, and synchronize the LED lighting effects with the beats of the music (i.e., audio signal). The device is powered by a rechargeable, replaceable battery and features a USB, micro-USB, or Type-C charging port for convenient power management.

In this manner, the interactive markerboard device of the present invention fulfills the long-felt need for a modern, multi-functional, and interactive drawing surface that enhances creativity while addressing the limitations of traditional markerboards and digital screens. The device provides an immersive LED lighting experience synchronized with music beats, making it ideal for entertainment, education, and professional use. The interactive markerboard device provides a modern, mess-free, and reusable solution that promotes creativity, learning, and entertainment while addressing the shortcomings of conventional markerboards and digital devices.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an interactive markerboard device. The markerboard device includes a glass markerboard surface, wherein the glass markerboard surface is transparent and shatter-resistant and is configured to enable a user to write or draw using a liquid neon-colored dry erase chalk marker. A durable and waterproof casing is disposed along a periphery or perimeter of the glass markerboard surface, the casing encloses and protects internal electronic components of the interactive markerboard device. A plurality of LEDs are embedded in the casing around the periphery or perimeter of the glass markerboard surface and enclosed within the casing, wherein the LEDs are configured to illuminate the glass markerboard surface in customizable static or dynamic colors. A Bluetooth speaker is integrated within the casing and is configured to pair with an external electronic device for receiving and outputting audio.

In another aspect, a microcontroller is communicatively coupled to the Bluetooth speaker and the plurality of LEDs, the microcontroller configured to process an audio signal received from the Bluetooth speaker, extract bass, mid, and treble frequencies from the audio signal, and control the illumination of the plurality of LEDs based on the extracted frequencies to create a synchronized visual effect in response to music beats.

In one embodiment, the interactive markerboard device includes a power button disposed on the casing for activating and deactivating the LEDs and the Bluetooth speaker, a built-in battery is electrically connected to the microcontroller, the plurality of LEDs, and the Bluetooth speaker, wherein the built-in battery is rechargeable and replaceable, and a charging port is integrated within the casing, the charging port is configured to charge the built-in battery via one or more of USB, micro-USB, or Type-C connections.

In yet another aspect, the device detects handwriting or drawings on the glass markerboard surface, processes the detected handwriting or drawings, and converts the handwritten text into digital text and/or provide AI-assisted drawing suggestions based on recognized patterns.

In another aspect, a method for using an interactive markerboard device is described. The method includes the steps of activating the device by pressing a power button disposed on the casing, wherein the power button initiates the operation of the LEDs and the Bluetooth speaker, pairing the device with an external electronic device via Bluetooth, Wi-Fi, or another wireless communication protocol to enable audio streaming through an integrated Bluetooth speaker, playing an audio track on the paired electronic device, wherein the microcontroller processes the received audio signal and extracts frequency components, and synchronizing the plurality of LEDs with the music beats, wherein the microcontroller generates LED control signals that dynamically adjust the brightness, color, and pattern of the LEDs in response to the detected audio beats.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of interactive ‘chalk’ markerboard of the present invention in accordance with the disclosed structure;

FIG. 2 illustrates a block diagram showing components of the multifunctional markerboard device of the present invention used in synchronization of the LEDs with music beats in accordance with one embodiment of the present invention;

FIG. 3 illustrates a flow chart depicting a process of using the multifunctional markerboard device of the present invention;

FIG. 4 illustrates a flow chart depicting a process of syncing LEDs and music in accordance with the disclosed structure; and

FIG. 5 illustrates a perspective view of the multifunctional markerboard device with a kickstand in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an interactive markerboard device that enhances creativity while reducing reliance on traditional markerboards and digital screens. There is a long-felt need for a mess-free writing and drawing solution that eliminates chalk dust and the frequent replacement of dry erase markers. Additionally, there is a long-felt need for an illuminated markerboard surface that enhances visibility in dim environments and adds a dynamic visual effect for entertainment, education, and creative expression. Furthermore, there exists a long-felt need in the art for an interactive writing surface that integrates multimedia functionality, enabling users to experience synchronized lighting and music playback. More specifically, there exists a long-felt need for a smart markerboard that synchronizes LED lighting with music beats, creating an engaging and immersive experience. Also, there is a long-felt need in the art for a wirelessly connected markerboard device that enables users to pair the markerboard with an electronic device via Bluetooth to play music and audio. Finally, there is a long-felt need for an eco-friendly, rechargeable, and multi-functional markerboard system that offers a creative drawing surface for individuals to draw, write, and express themselves on.

The present invention, in one exemplary embodiment, is a method for using an interactive markerboard device. The method includes the steps of activating the device by pressing a power button disposed on the casing, wherein the power button initiates the operation of the LEDs and the Bluetooth speaker, pairing the device with an external electronic device via Bluetooth, Wi-Fi, or another wireless communication protocol to enable audio streaming through an integrated Bluetooth speaker, playing an audio track on the paired electronic device, wherein the microcontroller processes the received audio signal and extracts frequency components, and synchronizing the plurality of LEDs with the music beats, wherein the microcontroller generates LED control signals that dynamically adjust the brightness, color, and pattern of the LEDs in response to the detected audio beats.

Reference will now be made in detail to the present preferred embodiments of the invention, examples of which are illustrated in the accompanying drawings. Wherever possible, the same reference numerals are used in the drawings and the description to refer to the same or like parts.

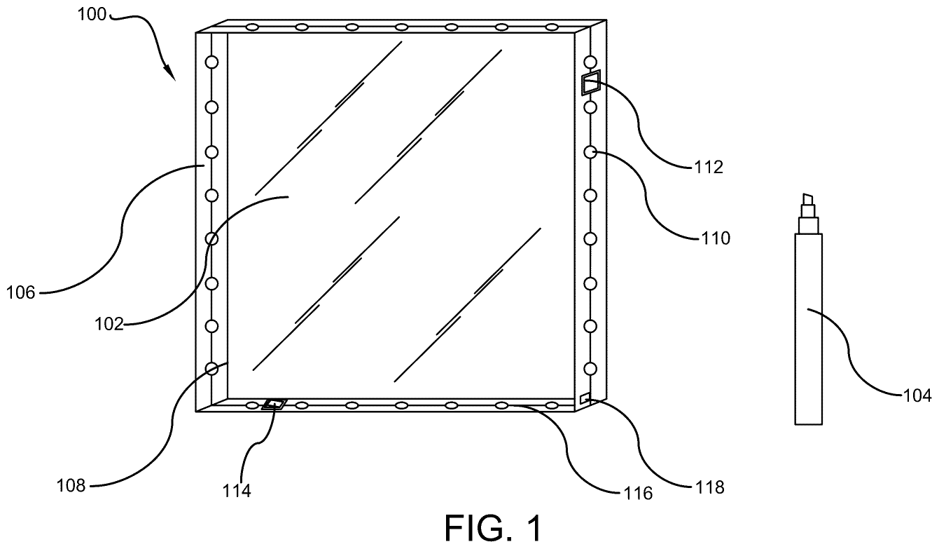

Referring initially to the drawings, FIG. 1 illustrates a perspective view of one potential embodiment of an interactive ‘chalk’ markerboard of the present invention in accordance with the disclosed structure. The interactive ‘chalk’ markerboard 100 of the present invention is designed as an interactive device designed to enhance creativity while minimizing screen time. The interactive ‘chalk’ markerboard 100 is a multifunctional board which includes a glass ‘chalk’ markerboard surface 102. The glass ‘chalk’ markerboard surface 102 is preferably transparent and is shatter-resistant. The glass ‘chalk’ markerboard surface 102 enables users to write or draw using a liquid neon-colored dry erase chalk marker or erasable marker 104.

A durable and waterproof casing 106 is disposed along and around the periphery 108 of the ‘chalk’ markerboard surface 102 and is configured to protect the internal electronic components of the interactive ‘chalk’ markerboard device 100. The casing 106 is suitable for various environments, including classrooms, homes, and public spaces. A plurality of LEDs 110 are embedded in the casing around the perimeter of the glass ‘chalk’ markerboard surface 102 and are enclosed by the casing 106. The LEDs 110 are configured to illuminate in static colors or dynamic colors, along with changing patterns to illuminate the ‘chalk’ markerboard surface 102 in multiple and customized colors.

A Bluetooth speaker 112 is integrated into the ‘chalk’ markerboard device 100 and enables wireless pairing with electronic devices such as smartphones, tablets, laptops, and more. The speaker 112 is adapted to receive audio signal from a paired device and provide high-quality audio output. In the preferred embodiment, the LEDs 110 sync with the rhythm of the music (i.e., audio signal) to enhance engagement and to create a visual experience that responds to music beats.

A power button 114 is disposed on the casing 106 for activating and deactivating the electronic components (such as speaker 112 and the LEDs 110). A built-in battery 116 provides electrical power to the electronic components and can be in the form of Li-Ion or Li-Ni battery. Further, the battery 116 is replaceable and rechargeable and can be recharged using the charging port 118, which can be one or more from USB, micro-USB, type C, or any other charging port.

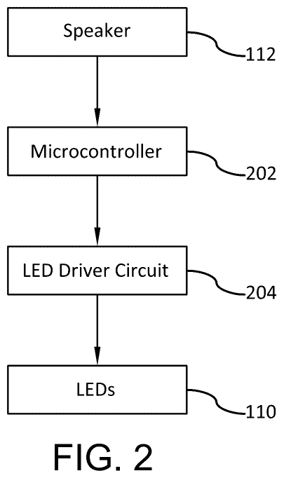

FIG. 2 illustrates a block diagram showing components of the multifunctional markerboard device of the present invention used in synchronization of the LEDs with music beats in accordance with one embodiment of the present invention. The ‘chalk’ markerboard device 100 includes a microcontroller 202 to process audio signals and control the LEDs 110. The LEDs 110 are preferably in the form of one or more LED strips, each strip has addressable RGB LEDs to enable dynamic lighting control. An LED driver circuit 204 is coupled with the microcontroller 202 for driving the power and brightness of LEDs.

The microcontroller 202 is also coupled with the Bluetooth speaker 112 and processes the audio being played by the speaker 112. The microcontroller 202 extracts bass, mid, and treble frequencies from the audio using a transformation technique such as Fast Fourier Transform (FFT), thereby identifying the beats in real-time in the audio. The microcontroller 202 sends signals to the addressable LEDs 110 to display dynamic lighting effects, wherein the LED driver circuit 204 enables LEDs to change brightness and intensity based on the amplitude or frequency of the beats or audio signal. In a non-limiting example, LEDs 110 may flash in sync with strong beats (from 2 KHz to 20 KHz). The LEDs 110 may form different zones based on frequency bands for creating a dynamic lighting effect. The LEDs 110 can also be trained to detect different music genres and apply adaptive lighting effects accordingly, such as intense bass pulses with strobe effects for Hip-Hop & EDM.

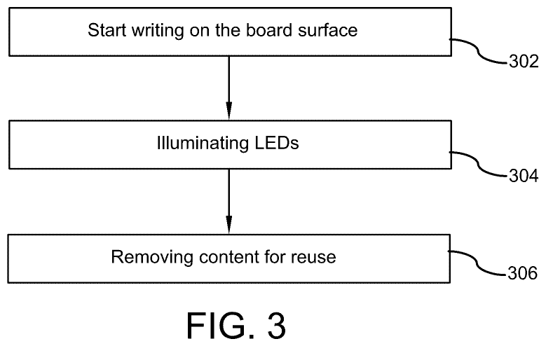

FIG. 3 illustrates a flow chart depicting a process of using the multifunctional markerboard device of the present invention. Initially, a user picks up a liquid ‘chalk’ marker (i.e., erasable marker) and starts drawing/writing on the board surface 102 (Step 302). The LEDs 110 illuminate and project light on the board surface 102 for creating a dynamic lighting effect (Step 304). The user can use an eraser, wet cloth, or any other similar item to remove or ‘erase’ the content for reusing the device 100 (Step 306).

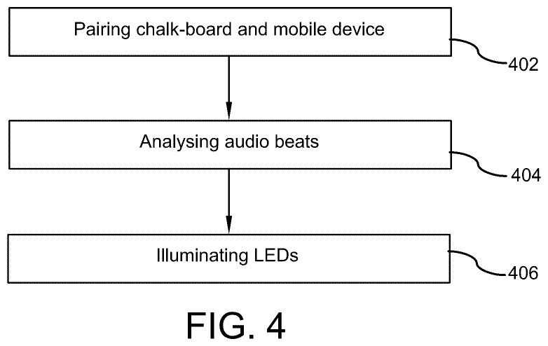

FIG. 4 illustrates a flow chart depicting a process of syncing LEDs and music in accordance with the disclosed structure. Initially, the ‘chalk’ markerboard device 100 is paired with a mobile device for receiving music (Step 402). Preferably, the device 100 uses Bluetooth for pairing, but pairing can be done using Wi-Fi, NFC, RFID, or any other short-range or long-range communication. Then, on receiving the audio, the microcontroller 202 analyzes the audio beats and sends an instruction signal to the LED driver 204 (Step 404). Accordingly, based on beats of the music (i.e., audio signal), the LEDs illuminate in the customized pattern (Step 406).

In some embodiments, the device 100 is configured to automatically convert handwritten notes on the board surface 102 into digital text and may provide real-time AI-assisted sketches or templates based on what the user is drawing using the microcontroller 202.

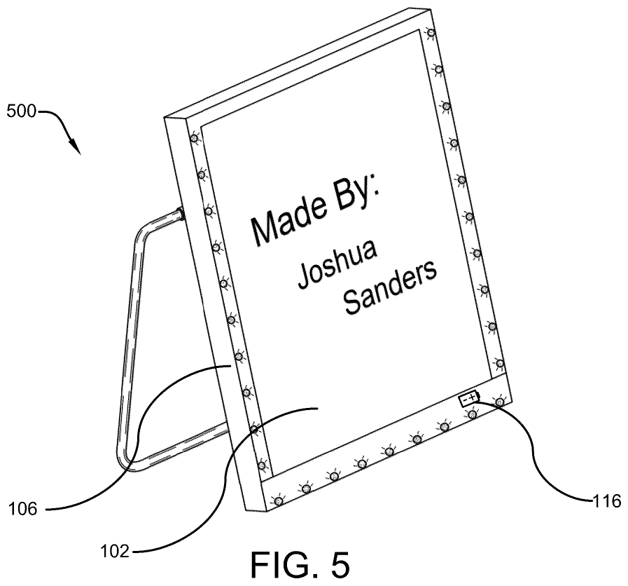

FIG. 5 illustrates a perspective view of the multifunctional markerboard device with a kickstand in accordance with one embodiment of the present invention. The device 100 can be used in various orientations and can be hung on a wall and placed on a surface. In the present embodiment, a kickstand 500 is used for accommodating and supporting the device 100 and the kickstand 500 can be included in a kit along with the multifunctional markerboard device 100. The kickstand 500 can orient the device 100 in various orientations and enables users of different ages to use the device 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “interactive markerboard device”, “multifunctional markerboard device”, “multifunctional smart markerboard”, “markerboard device”, and “device” are interchangeable and refer to the multifunctional smart markerboard device 100 of the present invention.

Notwithstanding the foregoing, the multifunctional smart markerboard device 100 of the present invention can be of any suitable configuration as is known in the art without affecting the overall concept of the invention, provided that it accomplishes the above-stated objectives. One of ordinary skill in the art will appreciate that the multifunctional smart markerboard device 100, as shown in the FIGS. are for illustrative purposes only, and that many other configurations of the multifunctional smart markerboard device 100 are well within the scope of the present disclosure. Although the dimensions of the multifunctional smart markerboard device 100 are important design parameters for user convenience, the multifunctional smart markerboard device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An interactive markerboard device comprising:
a markerboard device having a glass markerboard surface, a waterproof casing, and a plurality of electronic components;
a plurality of erasable markers;
wherein said glass markerboard surface is transparent;
wherein said plurality of erasable markers are liquid dry erase markers;
wherein said casing disposed around a periphery of said glass markerboard surface;
wherein said casing having said plurality of LEDs embedded in said casing around said periphery of said glass markerboard surface;
wherein said plurality of LEDs illuminate said glass markerboard surface selectively from the group consisting of static colors, dynamic colors, and changing patterns; and
further wherein said plurality of electronic components selected from the group consisting of a power button, a Bluetooth speaker, a plurality of LEDs, a battery, and a microcontroller.

2. The interactive markerboard device of claim 1, wherein said markerboard device wirelessly paired with another electronic device selected from the group consisting of a smartphone, a tablet, and a laptop.

3. The interactive markerboard device of claim 2, wherein said Bluetooth speaker receives an audio signal from said another electronic device.

4. The interactive markerboard device of claim 3, wherein said plurality of LEDs sync with a rhythm of said audio signal.

5. The interactive markerboard device of claim 4, wherein said power button disposed on said casing for activating and deactivating said electronic components.

6. The interactive markerboard device of claim 5, wherein said battery providing electrical power to said electronic components.

7. The interactive markerboard device of claim 6, wherein said microcontroller processes said audio signal and said plurality of LEDs.

8. The interactive markerboard device of claim 7, wherein said glass markerboard surface is shatter-resistant.

9. A method of interacting with a markerboard device, the method comprising the steps of:
providing a markerboard device having a glass markerboard surface, a waterproof casing, a plurality of electronic components, and a plurality of erasable markers, wherein said glass markerboard surface is transparent, wherein said plurality of erasable markers are liquid dry erase markers;
mounting said casing around a periphery of said glass markerboard surface;
embedding said plurality of LEDs in said casing around said periphery of said glass markerboard surface, wherein said plurality of LEDs illuminate said glass markerboard surface selectively from the group consisting of static colors, dynamic colors, and changing patterns, wherein said plurality of electronic components selected from the group consisting of a power button, a Bluetooth speaker, a plurality of LEDs, a battery, and a microcontroller;
coupling said microcontroller with said Bluetooth speaker; and
processing said audio signal being played by said Bluetooth speaker.

10. The method of interacting with a markerboard device of claim 9, wherein said markerboard device wirelessly paired with another electronic device selected from the group consisting of a smartphone, a tablet, and a laptop.

11. The method of interacting with a markerboard device of claim 10, wherein said Bluetooth speaker receives an audio signal from said another electronic device.

12. The method of interacting with a markerboard device of claim 11, wherein said plurality of LEDs sync with a rhythm of said audio signal.

13. The method of interacting with a markerboard device of claim 12, wherein said power button disposed on said casing for activating and deactivating said electronic components.

14. The method of interacting with a markerboard device of claim 13, wherein said battery providing electrical power to said electronic components.

15. The method of interacting with a markerboard device of claim 14, wherein said microcontroller processes said audio signal and said plurality of LEDs.

16. The method of interacting with a markerboard device of claim 15, wherein said glass markerboard surface is shatter-resistant.

17. A method of interacting with a markerboard device, the method comprising the steps of:
providing a markerboard device having a glass markerboard surface, a waterproof casing, a plurality of electronic components, and a plurality of erasable markers, wherein said glass markerboard surface is transparent, wherein said plurality of erasable markers are liquid dry erase markers;
mounting said casing around a periphery of said glass markerboard surface;
embedding said plurality of LEDs in said casing around said periphery of said glass markerboard surface, wherein said plurality of LEDs illuminate said glass markerboard surface selectively from the group consisting of static colors, dynamic colors, and changing patterns, wherein said plurality of electronic components selected from the group consisting of a power button, a Bluetooth speaker, a plurality of LEDs, a battery, and a microcontroller;
coupling said microcontroller with said Bluetooth speaker;
processing said audio signal being played by said Bluetooth speaker;
extracting a bass frequency, a mid frequency, and a treble frequency with said microcontroller from said audio signal; and
changing a brightness and an intensity of said plurality of LEDs based on an amplitude of said audio signal.

18. The method of interacting with a markerboard device of claim 17, wherein said markerboard device wirelessly paired with another electronic device selected from the group consisting of a smartphone, a tablet, and a laptop.

19. The method of interacting with a markerboard device of claim 18, wherein said Bluetooth speaker receives an audio signal from said another electronic device.

20. The method of interacting with a markerboard device of claim 19 further comprising the step of transforming said audio signal with a Fast Fourier Transform (FFT) for identifying said audio signal in real-time.
